(19) United States
(12) Patent Application Publication
(10) Pub. No.: US 2025/0158119 A1
(43) Pub. Date: May 15, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Olga TSAY, Yongin-si (KR); Seunghyeon SON, Yongin-si (KR); SANGHOON KIM, Yongin-si (KR); TAE HYON BAE, Yongin-si (KR); Harim LEE, Yongin-si (KR); Youngkyeong SHIN, Yongin-si (KR); Sanghyung KIM, Yongin-si (KR)

(21) Appl. No.: 18/766,280

(22) Filed: Jul. 8, 2024

(30) Foreign Application Priority Data
Nov. 9, 2023 (KR) 10-2023-0154744

(51) Int. Cl. H01M 10/0567; H01M 10/052; H01M 10/0569

(52) U.S. Cl. CPC H01M 10/0567; H01M 10/052; H01M 10/0569

(57) ABSTRACT

An electrolyte for a rechargeable lithium battery includes a non-aqueous organic solvent, a lithium salt, and a salt additive including a sulfonyl group substituted with a perhalogenated alkyl group and a cyano group. In addition, a rechargeable lithium battery including the electrolyte is also disclosed.

### CROSS-REFERENCE TO RELATED APPLICATION

The present application claims priority to and the benefit of Korean Patent Application No. 10-2023-0154744, filed on Nov. 9, 2023, in the Korean Intellectual Property Office, the entire content of which is incorporated herein by reference.

### BACKGROUND

### 1. Field

One or more embodiments of the present disclosure relates to an electrolyte for a rechargeable lithium battery and a rechargeable lithium battery including the same.

### 2. Description of Related Art

Recently, with the rapid spread and popularization of battery-utilizing electronic devices, such as mobile phones, laptop computers, and electric vehicles, there is a rapidly increasing demand for rechargeable batteries with relatively high energy density and relatively high capacity. Therefore, intensive research has been conducted to improve performance of rechargeable lithium batteries.

A rechargeable lithium battery includes a positive electrode, a negative electrode, and an electrolyte. The positive and negative electrodes each include an active material capable of intercalating and de-intercalating of lithium ions, and electrical energy is generated due to oxidation and reduction reactions when lithium ions are intercalated and de-intercalated.

A lithium salt dissolved in a non-aqueous organic solvent is utilized as the electrolyte of the rechargeable lithium battery. Characteristics of the rechargeable lithium battery are exhibited by complex reactions between the positive electrode and the electrolyte and between the negative electrode and the electrolyte. Accordingly, the utilization of an appropriate or suitable electrolyte is one of importance variables for improvement of the rechargeable lithium battery.

### SUMMARY

One or more aspects of embodiments of the present disclosure are directed toward an electrolyte for a rechargeable lithium battery with improved lifetime and stability.

One or more aspects of embodiments of the present disclosure are directed toward a rechargeable lithium battery including the electrolyte.

Additional aspects will be set forth in part in the description which follows and, in part, will be apparent from the description, or may be learned by practice of the presented embodiments of the disclosure.

According to one or more embodiments of the present disclosure, an electrolyte for a rechargeable lithium battery may include: a non-aqueous organic solvent; a lithium salt; and a salt additive including a sulfonyl group substituted with a perhalogenated alkyl group and a cyano group.

According to one or more embodiments of the present disclosure, a rechargeable lithium battery may include: a positive electrode that includes a positive electrode active material; a negative electrode that includes a negative electrode active material; and a salt additive including a sulfonyl group substituted with a perhalogenated alkyl group and a cyano group.

### BRIEF DESCRIPTION OF DRAWINGS

The above and other aspects, features, and advantages of certain embodiments of the present disclosure will be more apparent from the following description taken in conjunction with the accompanying drawings.

FIG. 1 illustrates a simplified conceptual diagram showing a rechargeable lithium battery according to one or more embodiments of the present disclosure.

FIGS. 2-5 each illustrate a simplified cross-sectional view showing a rechargeable lithium battery according to one or more embodiments of disclosure.

FIG. 6A illustrates a graph showing an initial electrochemical impedance spectroscopy (EIS) of each of the rechargeable lithium batteries of Embodiment 3 and Comparative Example 1 under the condition of SOC 100.

FIG. 6B illustrates a graph showing an initial EIS after 100 cycles of each of the rechargeable lithium batteries of Embodiment 3 and Comparative Example 1 under the condition of SOC 100.

FIG. 7 illustrates a graph showing evaluation results of lithium symmetric cells of rechargeable lithium batteries in accordance with Embodiment 3 and Comparative Example 1.

FIG. 8A illustrates a graph showing results of negative electrode cyclic voltammetry (CV) in accordance with Embodiment 3 and Comparative Example 1.

FIG. 8B illustrates a graph showing results of positive electrode cyclic voltammetry (CV) in accordance with Embodiment 3 and Comparative Example 1.

### DETAILED DESCRIPTION

In order to sufficiently understand the configurations and aspects of the present disclosure, one or more embodiments of the present disclosure will be described with reference to the accompanying drawings. It should be noted, however, that the present disclosure is not limited to the following example embodiments, and may be implemented in one or more suitable forms. Rather, the example embodiments are provided only to illustrate the present disclosure and let those skilled in the art fully know the scope of the present disclosure.

In the present disclosure, it will be understood that, if (e.g., when) an element is referred to as being on another element, the element may be directly on the other element or intervening elements may be present therebetween. In the drawings, thicknesses of some components may be exaggerated for effectively explaining the technical contents. Like reference numerals refer to like elements throughout the present disclosure, and duplicative descriptions thereof may not be provided for conciseness.

Unless otherwise specially noted in the present disclosure, the singular forms “a,” “an,” and “the” are intended to include the plural forms as well, unless the context clearly indicates otherwise. Further, the utilization of “may” when describing embodiments of the present disclosure refers to “one or more embodiments of the present disclosure”. In one or more embodiments, unless otherwise specially noted, the phrase “A or B” or “A and/or B” or “A/B” may indicate “A but not B”, “B but not A”, and “A and B”. The terms “comprises/includes” and/or “comprising/including” utilized in the present disclosure do not exclude the presence or addition of one or more other components.

In the present disclosure, the term “combination thereof” may refer to a mixture, a stack, a composite, a copolymer, an alloy, a blend, or a reaction product.

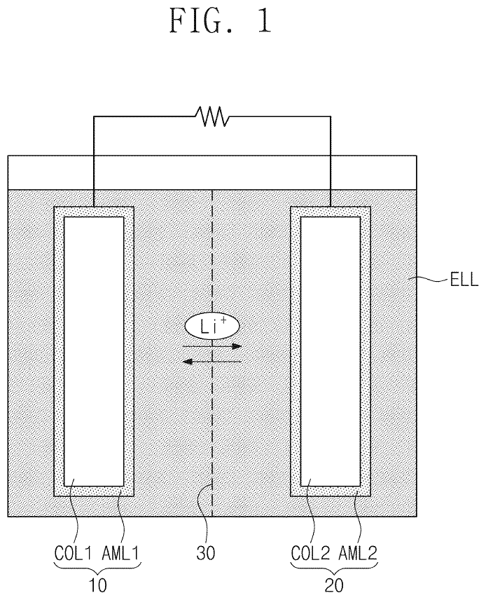

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. For example, the positive electrode 10, the negative electrode 20, and the separator 30 may be impregnated in the electrolyte ELL.

The electrolyte ELL may be a medium through which lithium ions are transferred between the positive electrode 10 and the negative electrode 20. In the electrolyte ELL, the lithium ions may move through the separator 30 toward one of (e.g., selected from among) the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and may further include a binder and/or a conductive material.

For example, in some embodiments, the positive electrode 10 may further include an additive that may serve as a sacrificial positive electrode.

An amount of the positive electrode active material may be in a range of about 90 wt % to about 99.5 wt % based on 100 wt % of a total weight of the positive electrode active material layer AML1. Amounts of the binder and the conductive material may each be about 0.5 wt % to about 5 wt % based on 100 wt % of the total weight of the positive electrode active material layer AML1.

The binder may serve to improve attachment of positive electrode active material particles to each other and also to improve attachment of the positive electrode active material to the current collector COL1. The binder may include, for example, one or more selected from among polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and nylon, but embodiments of the present disclosure are not limited thereto.

The conductive material (e.g., an electrically conductive material) may be utilized to provide an electrode with conductivity, and any suitable conductive material without causing chemical change of a battery may be utilized as the conductive material to constitute the battery. The conductive material may include, for example, a carbon-based material such as natural graphite, artificial graphite, carbon black, acetylene black, Ketjen black, carbon fiber, carbon nano-fiber, and/or carbon nano-tube; a metal powder or metal fiber containing one or more of (e.g., selected from among) copper, nickel, aluminum, and silver; a conductive polymer such as a polyphenylene derivative; and/or a (e.g., any suitable) mixture thereof.

In one or more embodiments, aluminum (Al) may be utilized as the current collector COL1, but embodiments of the present disclosure are not limited thereto.

### Positive Electrode Active Material

The positive electrode active material in the positive electrode active material layer AML1 may include a compound (e.g., lithiated intercalation compound) that may reversibly intercalate and de-intercalate lithium. For example, in one or more embodiments, the positive electrode active material may include at least one kind of composite oxide including lithium and metal(s) that is selected from among cobalt, manganese, nickel, and/or a (e.g., any suitable) combination thereof.

The composite oxide may include lithium transition metal composite oxides, for example, lithium-nickel-based oxides, lithium-cobalt-based oxides, lithium-manganese-based oxides, lithium-iron-phosphate-based compounds, cobalt-free nickel-manganese-based oxides, and/or a (e.g., any suitable) combination thereof.

For example, in one or more embodiments, the positive electrode active material may include a compound represented by one of (e.g., one selected from among) the following chemical formulae: LiₐA_{1-b}X_{b}O_{2-c}D_{c} (0.90≤a≤1.8, 0≤b≤0.5, 0≤c≤0.05), LiₐMn_{2-b}X_{b}O_{4-c}D_{c} (0.90≤a≤1.8, 0≤b≤0.5, 0≤c≤0.05), LiₐNi_{1-b-c}Co_{b}X_{c}O_{2-α}D_{α} (0.90≤a≤1.8, 0≤b≤0.5, 0≤c≤0.5, 0<α<2), LiₐNi_{1-b-c}Mn_{b}X_{c}O_{2-α}D_{α} (0.90≤a≤1.8, 0≤b≤0.5, 0≤c≤0.5, 0<α<2), LiₐNi_{b}Co_{c}L¹_{d}GₑO₂ (0.90≤a≤1.8, 0≤b≤0.9, 0≤c≤0.5, 0≤d≤0.5, 0≤e≤0.1), LiₐNiG_{b}O₂ (0.90≤a≤1.8, 0.001≤b≤0.1), LiₐCoG_{b}O₂ (0.90≤a≤1.8, 0.001≤b≤0.1), LiₐMn_{1-b}G_{b}O₂ (0.90≤a≤1.8, 0.001≤b≤0.1), LiₐMn₂G_{b}O₄ (0.90≤a≤1.8, 0.001≤b≤0.1), LiₐMn_{1-g}G_{g}PO₄ (0.90≤a≤1.8, 0≤g≤0.5), Li_{(3-f)}Fe₂(PO₄)₃ (0≤f≤2), and LiₐFePO₄ (0.90≤a≤1.8).

In the foregoing chemical formulae, A may be nickel (Ni), cobalt (Co), manganese (Mn), and/or a (e.g., any suitable) combination thereof, X may be Al, Ni, Co, Mn, chromium (Cr), iron (Fe), magnesium (Mg), strontium (Sr), vanadium (V), a rare element, and/or a (e.g., any suitable) combination thereof, D may be oxygen (O), fluorine (F), sulfur(S), phosphorous (P), and/or a (e.g., any suitable) combination thereof, may be is Al, Cr, Mn, Fe, Mg, lanthanum (La), cerium (Ce), Sr, V, and/or a (e.g., any suitable) combination thereof, and L¹ may be Mn, Al, and/or a (e.g., any suitable) combination thereof.

For example, in one or more embodiments, the positive electrode active material may be a high nickel-based positive electrode active material having a nickel content (e.g., amount) of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % based on 100 mol % of a total metal except lithium in the lithium transition metal composite oxide. The high nickel-based positive electrode active material may achieve relatively high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material and may further include a binder and/or a conductive material.

For example, in one or more embodiments, the negative electrode active material layer AML2 may include a negative electrode active material of about 90 wt % to about 99 wt %, a binder of about 0.5 wt % to about 5 wt %, and a conductive material of about 0 wt % to about 5 wt %, based on 100 wt % of a total weight of the negative electrode active material layer.

The binder may serve to improve attachment of negative electrode active material particles to each other and also to improve attachment of the negative electrode active material to the current collector COL2. The binder may include a non-aqueous (e.g., water-insoluble) binder, an aqueous (e.g., water-soluble) binder, a dry binder, and/or a (e.g., any suitable) combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include styrene-butadiene rubber, (meth)acrylated styrene-butadiene rubber, (meth)acrylic rubber, butyl rubber, a fluoro elastomer, polyethylene oxide, polyvinyl pyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenolic resin, an epoxy resin, polyvinyl alcohol, and/or a (e.g., any suitable) combination thereof.

When an aqueous binder is utilized as the binder of the negative electrode, a cellulose-based compound capable of providing viscosity may further be included. The cellulose-based compound may include one or more of (e.g., selected from among) carboxymethyl cellulose, hydroxypropylmethyl cellulose, methyl cellulose, and alkali metal salts thereof. The alkaline metal may include Na, K, or Li.

The dry binder may include a fibrillizable polymer material, for example, polytetrafluoroethylene, polyvinylidene fluoride, a polyvinylidene fluoride-hexafluoropropylene copolymer, polyethylene oxide, and/or a (e.g., any suitable) combination thereof.

The conductive material (e.g., electrically conductive material) may be utilized to provide an electrode with conductivity, and any suitable conductive material without causing chemical change of a battery may be utilized as the conductive material to constitute the battery. For example, in one or more embodiments, the conductive material may include a carbon-based material such as natural graphite, artificial graphite, carbon black, acetylene black, Ketjen black, carbon fiber, carbon nano-fiber, and/or carbon nano-tube; a metal powder or metal fiber including one or more of (e.g., selected from among) copper, nickel, aluminum, and silver; a conductive polymer such as a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that may reversibly intercalate and de-intercalate lithium ions, lithium metal, a lithium metal alloy, a material that may dope and de-dope lithium, or a transition metal oxide.

The material that may reversibly intercalate and de-intercalate lithium ions may include a carbon-based negative electrode active material, for example, crystalline carbon, amorphous carbon, and/or a (e.g., any suitable) combination thereof. For example, the crystalline carbon may include graphite such as non-shaped (e.g., irregularly shaped), sheet-shaped, flake-shaped, sphere-shaped, or fiber-shaped natural and/or artificial graphite, and the amorphous carbon may include soft carbon, hard carbon, mesophase pitch carbon, and/or calcined coke.

The lithium metal alloy may include an alloy of lithium and a metal that is selected from among sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material that may dope and de-dope lithium may include a Si-based negative electrode active material or a Sn-based negative electrode active material. The Si-based negative electrode active material may include silicon, silicon-carbon composite, SiOₓ (0<x≤2), a Si—Q alloy (where Q is an alkali metal, an alkaline earth metal, a Group 13 element, a Group 14 element (except for Si), a Group 15 element, a Group 16 element, a transition metal, a rare-earth element, and/or a (e.g., any suitable)combination thereof), and/or a (e.g., any suitable) combination thereof. The Sn-based negative electrode active material may include Sn, SnOₖ (0<k≤2) (e.g., SnO₂), a Sn-based alloy, or a (e.g., an suitable) combination thereof.

The silicon-carbon composite may be a composite of silicon and amorphous carbon (e.g., in a form of particles). According to one or more embodiments, the silicon-carbon composite may have a structure in which the amorphous carbon is coated on a surface of each of silicon particles. For example, in one or more embodiments, the silicon-carbon composite may include a secondary particle (core) in which primary silicon particles are assembled and an amorphous carbon coating layer (shell) on (e.g., positioned on) a surface of the secondary particle. The amorphous carbon may also be positioned between the primary silicon particles, and for example, the primary silicon particles may be coated with the amorphous carbon. The secondary particles may be present and dispersed in an amorphous carbon matrix.

In one or more embodiments, the silicon-carbon composite may further include crystalline carbon. For example, the silicon-carbon composite may include a core including crystalline carbon and silicon particles and may also include an amorphous carbon coating layer positioned on a surface of the core.

In some embodiments, the Si-based negative electrode active material and/or the Sn-based negative electrode active material may be utilized in combination with a carbon-based negative electrode active material.

### Separator 30

Based on type or kind of the rechargeable lithium battery, the separator 30 may be present between the positive electrode 10 and the negative electrode 20. The separator 30 may include one or more of (selected from among) polyethylene, polypropylene, and polyvinylidene fluoride, or may have a multi-layered separator thereof such as a polyethylene/polypropylene bi-layered separator, a polyethylene/polypropylene/polyethylene tri-layered separator, or a polypropylene/polyethylene/polypropylene tri-layered separator.

The separator 30 may include a porous substrate and a coating layer positioned on one surface or two opposite surfaces of the porous substrate, and the coating layer may include an organic material, an inorganic material, and/or a (e.g., any suitable) combination thereof.

The porous substrate may be a polymer layer including one selected from among polyolefin such as polyethylene and/or polypropylene, polyester such as polyethylene terephthalate and/or polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, a cyclic olefin copolymer, polyphenylenesulphide, polyethylene naphthalate, glass fiber, and polytetrafluoroethylene (e.g., Teflon), or may be a copolymer or a mixture including two or more thereof.

The organic material may include a polyvinylidenefluoride-based copolymer and/or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but embodiments of the present disclosure are not limited thereto.

In one or more embodiments, the organic material and the inorganic material may be present and mixed in one coating layer, or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may serve as a medium for transmitting ions that participate in an electrochemical reaction of a rechargeable lithium battery.

The non-aqueous organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, and/or caprolactone.

The ether-based solvent may include dibutyl ether, tetraglyme, diglyme, dimethoxyethane, 2-methyltetrahydrofuran, 2.5-dimethyltetrahydrofuran, and/or tetrahydrofuran. The ketone-based solvent may include cyclohexanone. The aprotic solvent may include nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane and/or 1.4-dioxolane; and/or sulfolanes.

The non-aqueous organic solvent may be utilized alone or in a mixture of two or more thereof.

In one or more embodiments, if (e.g., when) a carbonate-based solvent is utilized, a cyclic carbonate and a chain carbonate may be mixed and utilized, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a rechargeable lithium battery and plays a role in enabling a basic operation of the rechargeable lithium battery and in promoting the movement of lithium ions between the positive electrode and the negative electrode. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), LiC₄F₉SO₃, LiN(CₓF₂ₓ₊₁SO₂)(C_{y}F_{2y+1}SO₂) (where x and y are integers between 1 to 20), lithium trifluoromethane sulfonate, lithium tetrafluoroethanesulfonate, lithium difluorobis(oxalato)phosphate (LiDFBOP), and lithium bis(oxalato) borate (LiBOB).

### Rechargeable Lithium Battery

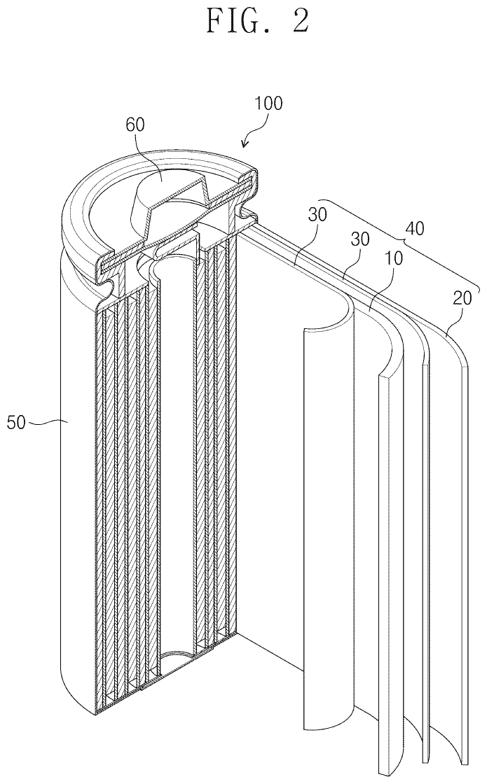

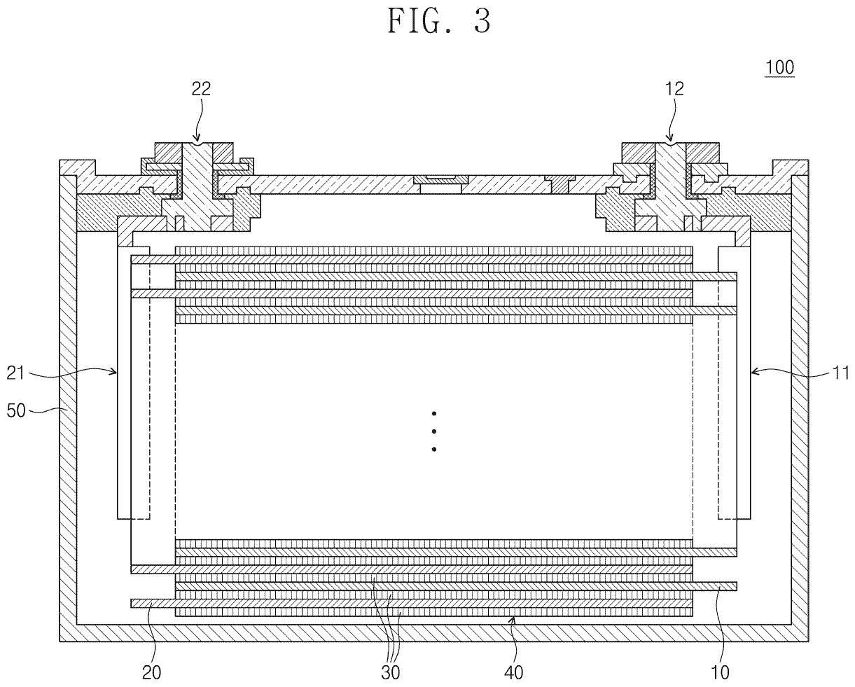

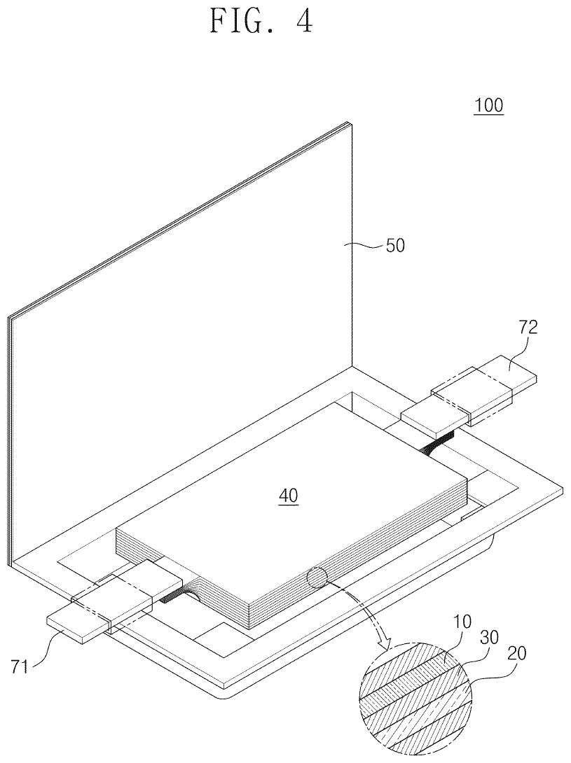

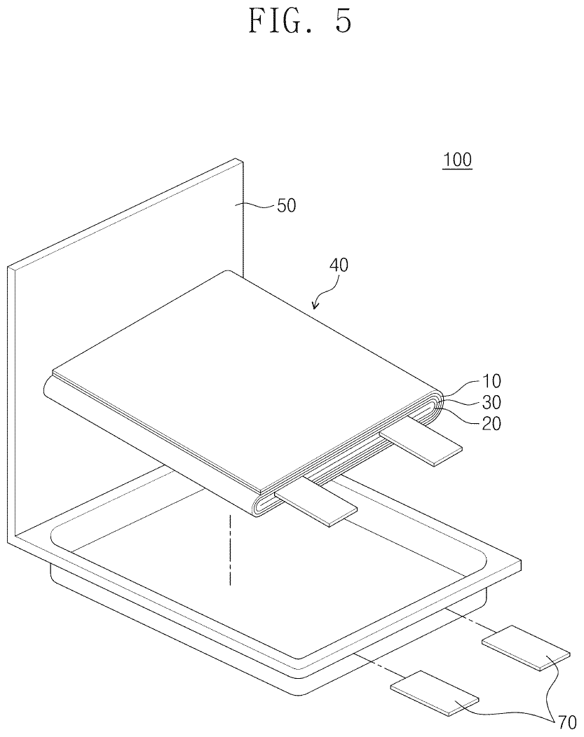

Based on the shape of a rechargeable lithium battery, the rechargeable lithium battery may be classified into cylindrical, prismatic, pouch, or coin types (kinds). FIGS. 2 to 5 each illustrate a simplified diagram showing a rechargeable lithium battery according to one or more embodiments of the present disclosure. FIG. 2 shows a cylindrical battery, FIG. 3 shows a prismatic battery, and FIGS. 4 and 5 each show a pouch-type or kind battery. Referring to FIGS. 2 to 5, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte. In some embodiments, the rechargeable lithium battery 100 may include a sealing member 60 that seals the casing 50 as illustrated in FIG. 2. In one or more embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, in one or more embodiments, the rechargeable lithium battery 100 may include an electrode tab 70, or a positive electrode tab 71 and a negative electrode tab 72, which serves as an electrical path for externally inducing a current generated in the electrode assembly 40.

The following will describe in more detail an electrolyte for a rechargeable lithium battery according to one or more embodiments of the present disclosure.

An electrolyte for a rechargeable lithium battery according to one or more embodiments may include a non-aqueous organic solvent, a lithium salt, and a salt additive including a sulfonyl group substituted with a perhalogenated alkyl group and a cyano group.

The electrolyte according to one or more embodiments of the present disclosure may be added with a salt additive including a sulfonyl group substituted with a perhalogenated alky group and a cyano group, and may form a stable film on an electrode surface to suppress or reduce the formation of a lithium dendrite. Therefore, the electrolyte according to one or more embodiments may effectively improve stability and cycle lifetime characteristics of a lithium battery.

The electrolyte may be manufactured by a mixing process in which the lithium salt is dissolved in the non-aqueous organic solvent and the salt additive is added to mix. The electrolyte mixing process is widely suitable in the electrolyte fabrication field, and a person skilled in the art will be able to appropriately or suitably select and utilize.

In one or more embodiments of the present disclosure, a rechargeable lithium battery may include a positive electrode including a positive electrode active material, a negative electrode including a negative electrode active material, and an electrolyte, and the electrolyte may include a non-aqueous organic solvent, a lithium salt, and a salt additive including a sulfonyl group substituted with a perhalogenated alky group and a cyano group.

In one or more embodiments, the non-aqueous organic solvent may include at least one selected from among ethylene carbonate (EC), propylene carbonate (PC), propyl propionate (PP), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

In one or more embodiments, the non-aqueous organic solvent may be, for example a mixture solvent of ethylene carbonate (EC), propyl carbonate (PC), and propyl propionate (PP).

For example, in some embodiments, the ethylene carbonate (EC) may be included at about 5 vol % to about 20 vol % based on a total volume of the non-aqueous organic solvent. The propylene carbonate (PC) may be included at about 10 vol % to about 30 vol % based on the total volume of the non-aqueous organic solvent. The propylene carbonate (PC) may be included at about 50 vol % to about 80 vol % based on the total volume of the non-aqueous organic solvent.

For example, in one or more embodiments, the lithium salt may include LiPF₆.

The lithium salt may have a concentration of about 0.1 M to about 2.0 M. For example, in one or more embodiments, the lithium salt may have a concentration of equal to or greater than about 0.5 M or equal to or greater than about 1.0 M. The lithium salt may have a concentration of equal to or less than about 2.0 M, equal to or less than about 1.7 M, or equal to or less than about 1.5 M. In the present disclosure, if (e.g., when) the lithium salt has a concentration of about 0.1 M to about 2.0 M, the electrolyte may appropriately or suitably maintain its conductivity and viscosity.

In one or more embodiments of the present disclosure, the salt additive may be a compound including a sulfonyl group substituted with a perhalogenated alkyl group and a cyano group. The sulfonyl group substituted with the perhalogenated alkyl group included in the salt additive may form a stable film on a surface of the positive electrode to improve lifetime performance of the rechargeable lithium battery. A complex may be formed by the cyano group included in the salt additive and transition metal ions of the positive electrode active material. The complex may form a modified protective layer with improved stability that maintains a rigidity state even after a long-time charge/discharge compared to a protective layer formed only by a decomposition of an organic solvent. As the protective layer effectively forbids a direction contact between the organic solvent and the positive electrode. Thus, the salt additive may effectively contribute to stability and cycle life characteristics of the rechargeable lithium battery.

The salt additive may have a salt structure that has the sulfonyl group substituted with both (e.g., simultaneously) the perhalogenated alkyl group and the cyano group, the salt additive may maintain a stable correlation not only with the positive electrode but also with the lithium salt, and may improve stability of a lithium battery at high voltages.

In one or more embodiments, the salt additive may have an amount of about 0.02 wt % to about 2.0 wt % relative to the total weight of the electrolyte. For example, in one or more embodiments, the salt additive may have an amount of about 0.1 wt % to about 1.5 wt % relative to the total weight of the electrolyte. In one or more embodiments, the salt additive may have an amount of about 0.5 wt % to about 1.0 wt % relative to the total weight of the electrolyte. When the salt additive has the aforementioned concentration in the electrolyte, a protective film having appropriate or suitable film resistance may be formed on an electrode surface of a lithium battery to improve cycle characteristics of the lithium battery.

The salt additive according to one or more embodiments of the present disclosure may be expressed by Chemical Formula 1.

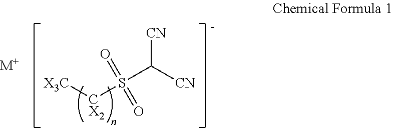

In Chemical Formula 1, M⁺ may be a univalent cation, n may be an integer between 1 and 5, and X may be a halogen element. In Chemical Formula 1, M⁺ may be one selected from among Li⁺, Na⁺, and K⁺. The halogen element may include fluorine, bromine, chlorine, iodine, and/or so forth.

For example, in the electrolyte for a rechargeable lithium battery according to one or more embodiments of the present disclosure, the salt additive may be expressed by Chemical Formula 1-1.

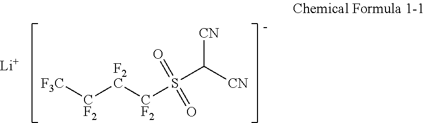

The salt additive according to Chemical Formula 1-1 may have a lithium salt structure in which a sulfonyl group substituted with a perfluoroalkyl group is included in a functional group.

For example, in the electrolyte for a rechargeable lithium battery according to one or more embodiments of the present disclosure, the salt additive may be expressed by Chemical Formula 1-2.

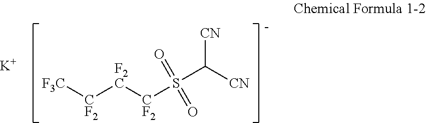

The salt additive according to Chemical Formula 1-2 may have a potassium salt structure in which a sulfonyl group substituted with a perfluoroalkyl group is included in a functional group.

In the rechargeable lithium battery utilizing the electrolyte according to the present disclosure, the positive electrode active material may include one or more of (e.g., selected from among) a lithium-cobalt-based oxide, a lithium nickel-based oxide, a lithium manganese-based oxide, a lithium iron phosphate-based compounds, a cobalt-free nickel-manganese-based oxide, and any combination thereof. For example, in one or more embodiments, the positive electrode active material may include a lithium cobalt-based oxide.

In the rechargeable lithium battery utilizing the electrolyte according to the present disclosure, the negative electrode active material may include a carbon-based negative electrode active material, a silicon-based negative electrode active material, or any combination thereof.

The rechargeable lithium battery according to one or more embodiments of the present disclosure may be applied to automotive vehicles, mobile phones, and/or any other electrical devices, but embodiments of the present disclosure are not limited thereto.

The following will describe Embodiments/Examples and Comparative Examples of the present disclosure. The following embodiments/examples are only some embodiments/examples of the present disclosure, and the present disclosure is not limited to the following embodiments/examples.

### EMBODIMENTS AND COMPARATIVE EXAMPLES

### Embodiment 1

### (1) Preparation of Electrolyte

LiPF₆ of about 1.3 M was dissolved in a non-aqueous organic solvent in which ethylene carbonate (EC), propylene carbonate (PC), propyl propionate (PP) are mixed in a volume ratio of about 10:15:75, and a salt additive of about 0.2 wt % was added to prepare an electrolyte.

A material represented by Chemical Formula 1-1 was utilized as the salt additive.

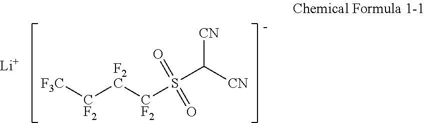

For example, the salt additive in accordance with Chemical Formula 1-1 may be manufacture by the following Synthesis Example.

### Synthesis Example

First, lithium hydride (0.54 g) was suspended in anhydrous tetrahydrofuran (THF) (60 mL). A solution in which malononitrile (1.98 g) was dissolved in anhydrous tetrahydrofuran (30 mL) was added dropwise at −30° C. in an inert gas environment to manufacture a reaction mixture. The reaction mixture was agitated until a hydrogen gas generation was terminated.

The reaction mixture was added to an anhydrous THF solution (60 mL) in which perfluorobutanesulfonyl fluoride (9.06 g) was dissolved. The reaction mixture was agitated at 0° C. for less than 4 hours. After that, the agitated reaction mixture was filtered and a filtrate was evaporated. Thereafter, a residue was dissolved in water of 30 mL and then poured into a saturated aqueous solution of potassium chloride (KCl) to filter a generated precipitate, and recrystallized with hot water to obtain a compound (KC₄F₉SO₂C(CN)₂) expressed by Chemical 1-2.

An anhydrous THF solution (20 mL) in which lithium chloride (0.713 g) was dissolved was added to a THF solution (50 mL) including the obtained KC₄F₉SO₂C(CN)₂ to filter a generated precipitate and a filtrate was evaporated, and then dried at a high-vacuum condition to obtain a compound expressed by Chemical Formula 1-1.

### (2) Fabrication of Rechargeable Lithium Battery

LiCoO₂ (LCO) of 97 wt %, artificial graphite powder of 0.5 wt % as a conductive material, carbon black (Ketjen black) of 0.8 wt %, acrylonitrile rubber of 0.2 wt %, polyvinylidene fluoride (PVdF) of 1.5 wt % were mixed and added to N-methyl-2-pyrrolidone, and then were agitated for 30 minutes by utilizing a mechanical agitator to manufacture a positive electrode active material slurry. A doctor blade was utilized to coat the positive electrode active material slurry with a thickness of about 60 μm on an aluminum current collector of about 20 μm, dried in a hot-air drier for 0.5 hours at 100° C., dried again for 4 hours at 120° C. in a vacuum condition, and then roll-pressed to manufacture a positive electrode.

Artificial graphite of 98 wt %, styrene-butadiene rubber (SBR) of 1 wt %, and carboxymethyl cellulose (CMC) of 1 wt % were mixed and added to distilled water, and then stirred for 60 minutes by utilizing a mechanical agitator to manufacture a negative electrode active material slurry. A doctor blade was utilized to coat the negative electrode active material slurry with a thickness of about 60 μm on a copper current collector of about 10 μm, dried in a hot-air drier for 0.5 hours at 100° C., dried again for 4 hours at 120° C. in a vacuum condition, and then roll-pressed to manufacture a negative electrode.

The positive electrode, the negative electrode, and a 10 μm-thick polyethylene separator were assembled to manufacture an electrode assembly, and the electrolyte was introduced to fabricate a rechargeable lithium battery.

### Embodiment 2

An electrolyte and a rechargeable lithium battery were each fabricated by substantially the same method as that of Embodiment 1, except that the salt additive of 0.5 wt % was applied.

### Embodiment 3

An electrolyte and a rechargeable lithium battery were each fabricated by substantially the same method as that of Embodiment 1, except that the salt additive of 1.0 wt % was applied.

### Embodiment 4

An electrolyte and a rechargeable lithium battery were each fabricated by substantially the same method as that of Embodiment 1, except that the salt additive of 2.0 wt % was applied.

### Embodiment 5

An electrolyte and a rechargeable lithium battery were each fabricated by substantially the same method as that of Embodiment 1, except that the salt additive of 0.2 wt % represented by Chemical Formula 1-2 manufactured from Synthesis Example was applied.

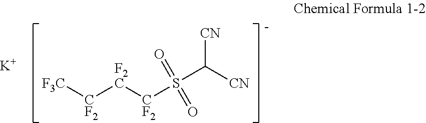

### Comparative Example 1

An electrolyte and a rechargeable lithium battery were each fabricated by substantially the same method as that of Embodiment 1, except that no salt additive was added at all when the electrolyte was fabricated.

### Evaluation Example

A rechargeable lithium battery was evaluated by the following method.

### Evaluation 1: Charge/Discharge Cycle Characteristics

The rechargeable lithium batteries prepared in Embodiments and Comparative Examples were each charged at 25° C. with a constant current at 0.2 C rate until a voltage was 4.53 V (vs. Li), and then the current was cut-off at 0.05 C rate while a voltage was maintained at 4.3 V in a constant voltage mode. Then, the battery was discharged with a constant current of 0.2 C rate until a voltage was 2.5 V (vs. Li) (formation process).

A high-temperature charge/discharge characteristics evaluation was conducted on each of the rechargeable lithium batteries that had undergone the formation process. The rechargeable lithium batteries were each charged and discharged at 45° C. for 100 cycles under the condition of charge (1.5 C/4.53 V, 0.05 C Cut-off, Rest 10 min.) and discharge (0.5 C/2.5 V Cut-off, Rest 10 min.).

After an initial discharge capacity and a post-100-cycle discharge capacity were measured, a capacity retention rate was calculated and its result was listed in Table 1. The capacity retention rate was calculated according to Equation 1.

$$Capacity retention rate ( \% ) = ( discharge capacity after 100 cycles / initial discharge capacity ) \times 100 \qquad Equation 1$$

TABLE 1

| | Initial | Discharge | Capacity retention |
|---|---|---|---|
| | discharge | capacity after 100 | rate after 100 |
| | capacity (mAh) | cycles (mAh) | cycles (%) |
| Embodiment 1 | 5.53 | 3.61 | 65.3 |
| Embodiment 2 | 5.57 | 3.68 | 66.1 |
| Embodiment 3 | 5.56 | 3.87 | 69.6 |
| Embodiment 4 | 5.56 | 3.34 | 60.1 |
| Embodiment 5 | 5.41 | 3.45 | 63.7 |
| Comparative | 5.60 | 3.08 | 54.9 |
| Example 1 | | | |

### Evaluation 2: Resistance Test

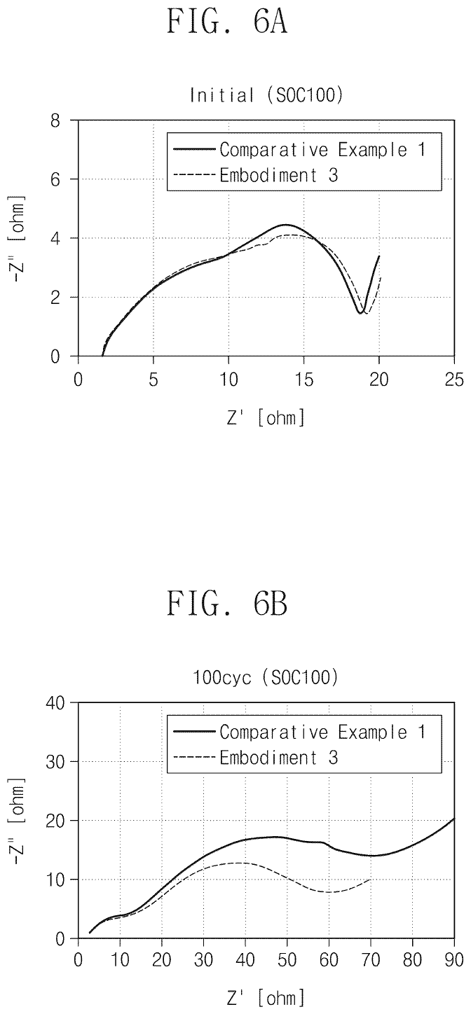

An electrochemical impedance spectroscopy (EIS) measurement was conducted based on state of charge (SOC) of each of the rechargeable lithium batteries manufactured by Embodiment 3 and Comparative Example 1. FIGS. 6A and 6B show a measured degree of resistance on an electrode interface at initial and after 100 cycles at 45° C.

FIG. 6A illustrates a graph showing an initial EIS of each of the rechargeable lithium batteries of Embodiment 3 and Comparative Example 1 under the condition of SOC 100.

FIG. 6B illustrates a graph showing an initial EIS after 100 cycles of each of the rechargeable lithium batteries of Embodiment 3 and Comparative Example 1 under the condition of SOC 100.

### Evaluation 3: Lithium Dendrite Characteristics

The electrolytes utilized in Embodiment 3 and Comparative Example 1 were separately utilized to fabricate Li/Li symmetric 2032-type or kind coin cells.

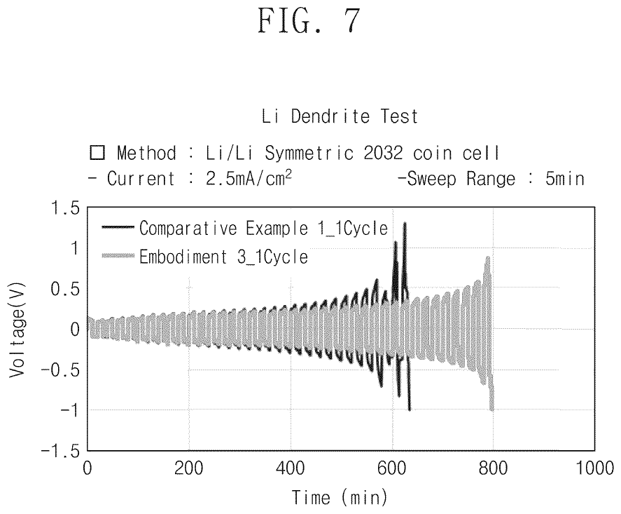

A lithium symmetric cell test was executed to ascertain lithium dendrite characteristics, and its results were depicted in FIG. 7. FIG. 7 illustrates a graph showing evaluation results of lithium symmetric cells of rechargeable lithium batteries in accordance with Embodiment 3 and Comparative Example 1. The lithium symmetric cell test was performed at a condition of current of 2.5 mA/cm² and sweep range of 5 minutes.

Evaluation 4: CV characteristics

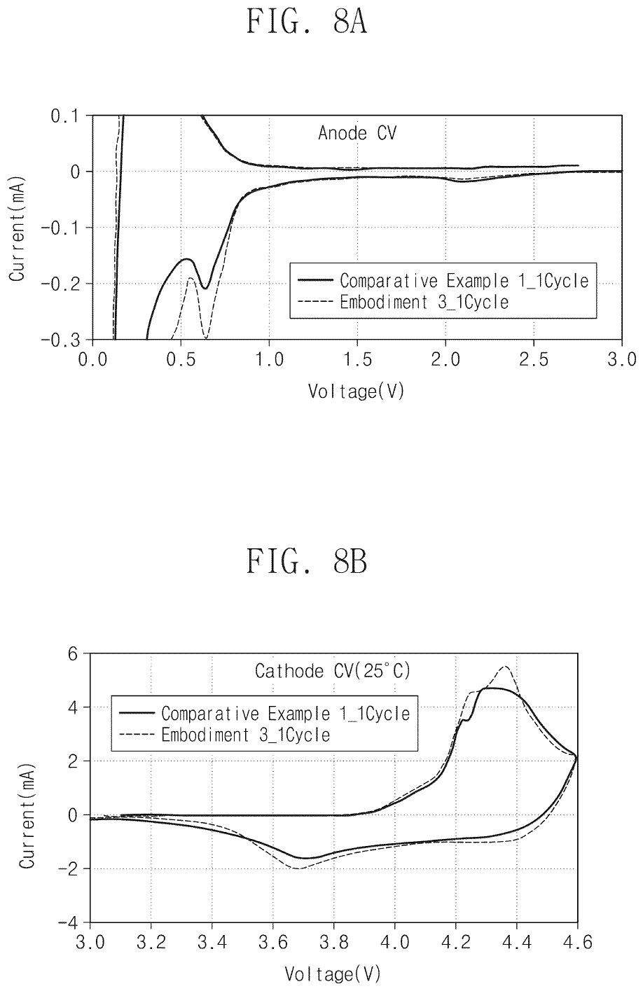

A cyclic voltammetry (CV) was measured at room temperature (25° C.) to evaluate electrochemical stability of the electrolytes utilized in Embodiment 3 and Comparative Example 1, and measured results were depicted in FIGS. 8A and 8B. FIG. 8A illustrates a graph showing results of negative electrode cyclic voltammetry (CV) in accordance with Embodiment 3 and Comparative Example 1. FIG. 8B illustrates a graph showing results of positive electrode cyclic voltammetry (CV) of electrolytes in accordance with Embodiment 3 and Comparative Example 1.

A negative CV measurement was performed by utilizing a graphite negative electrode was as a working electrode and Li metal as a counter electrode. In this case, scanning was performed from 3 V to 0 V for 3 cycles, a scanning speed was 0.1 mV/sec.

A positive CV measurement was performed by utilizing a cathode coin half-cell in which a lithium cobalt oxide (LCO) positive electrode was utilized as a working electrode and Li metal was utilized as a counter electrode. In this case, scanning was performed from 3 V to 4.6 V for 3 cycles, a scanning speed was 0.1 mV/sec.

### Comprehensive Evaluation

Referring to Table 1, it was ascertained that there was an improvement in capacity retention rate depending on the charge/discharge cycle in the cases (Embodiments 1 to 5) each utilizing an electrolyte that includes a salt additive according to the present disclosure in comparison with the case (Comparative Example 1) utilizing an electrolyte to which no salt additive is added at all. Therefore, if (e.g., when) a salt additive according to the present disclosure s is added to an electrolyte, it may be ascertained that there is an improvement in cycle characteristics and lifetime efficiency of a rechargeable lithium battery.

Referring to FIGS. 6A and 6B, it may be ascertained that there is a reduction in resistance increase after 100 cycles in the rechargeable lithium battery according to Embodiment 3, compared to the rechargeable lithium battery according to Comparative Example 1. Referring to FIG. 7, it was ascertained that the rechargeable lithium battery of Embodiment 3 had a lifetime superior to that of the rechargeable lithium battery of Comparative Example 1. Therefore, it may be expected that addition of the salt additive according to the present disclosure will help to suppress or reduce the formation of lithium dendrites on a surface of the negative electrode.

Referring to FIGS. 8A and 8B, it may be seen that the salt additive according to one or more embodiments causes the formation of a film on a surface of the negative electrode or the positive electrode to accomplish passivation. For example, the salt additive may be preferentially oxidized to an organic solvent that forms a protective layer on a surface of the positive electrode, and the protective layer may more effectively suppress or reduce direct contact between the organic solvent and the positive electrode, which may result in more improvement in reversibility of intercalation/deintercalation of lithium ions. Thus, the salt additive may effectively contribute to stability and cycle life characteristics of a lithium battery.

The electrolyte according to one or more embodiments of the present disclosure may include a salt additive including a sulfonyl group substituted with a perhalogenated alkyl group and a cyano group, and thus it may improve lifetime characteristics and stability at relatively high-voltage conditions when a rechargeable lithium battery is activated.

In the present disclosure, expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. The “/” utilized herein may be interpreted as “and” or as “or” depending on the situation.

In present disclosure, The term “Group” as utilized herein refers to a group of the Periodic Table of Elements according to the 1 to 18 grouping system of the International Union of Pure and Applied Chemistry (“IUPAC”).

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

While the disclosure has been described in connection with what is presently considered to be practical embodiments, it is to be understood that the present disclosure is not limited to the disclosed embodiments and is intended to cover one or more suitable modifications and equivalent arrangements included within the spirit and scope of the appended claims and equivalents thereof, and therefore the aforementioned embodiments should be understood to be exemplarily but not limiting this disclosure in any way.

What is claimed is:

1. An electrolyte comprising:
a non-aqueous organic solvent;
a lithium salt; and
a salt additive comprising a sulfonyl group substituted with a perhalogenated alkyl group and a cyano group,
wherein the electrolyte is for a rechargeable lithium battery.

2. The electrolyte as claimed in claim 1, wherein the salt additive is represented by Chemical Formula 1, 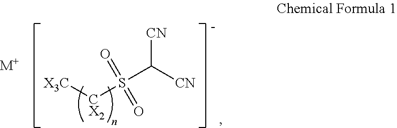
in Chemical Formula 1,
M⁺ being a univalent cation,
n being an integer between 1 and 5, and
X being a halogen element.

3. The electrolyte as claimed in claim 2, wherein the M⁺ of Chemical Formula 1 is one selected from among Li⁺, Na⁺, and K⁺.

4. The electrolyte as claimed in claim 1, wherein the salt additive is represented by Chemical Formula 1-1 or Chemical Formula 1-2,

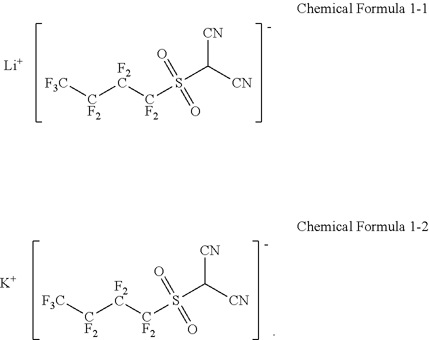

5. The electrolyte as claimed in claim 1, wherein the salt additive has an amount of about 0.02 wt % to about 2 wt % relative to a total weight of the electrolyte.

6. The electrolyte as claimed in claim 1, wherein the non-aqueous organic solvent comprises at least one selected from among ethylene carbonate, propylene carbonate, propyl propionate, ethylmethyl carbonate, dimethyl carbonate, diethyl carbonate, dipropyl carbonate, methylpropyl carbonate, ethylpropyl carbonate, methylethyl carbonate, and butylene carbonate.

7. The electrolyte as claimed in claim 1, wherein the lithium salt comprises at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide, and LiC₄F₉SO₃.

8. The electrolyte as claimed in claim 1, wherein a concentration of the lithium salt is in a range of 0.1 M to 2.0 M.

9. A rechargeable lithium battery, comprising:
a positive electrode that comprises a positive electrode active material;
a negative electrode that comprises a negative electrode active material; and
the electrolyte as claimed in claim 1.

10. The rechargeable lithium battery as claimed in claim 9, wherein the positive electrode active material comprises one or more selected from among a lithium cobalt-based oxide, a lithium nickel-based oxide, a lithium manganese-based oxide, a lithium iron phosphate-based compounds, a cobalt-free nickel-manganese-based oxide, and a combination thereof.

11. The rechargeable lithium battery as claimed in claim 9, wherein the negative electrode active material comprises a carbon-based negative electrode active material, a silicon-based negative electrode active material, or a combination thereof.
